(19) United States
(12) Patent Application Publication
(10) Pub. No.: US 2010/0188780 A1
(43) Pub. Date: Jul. 29, 2010

(54) ASSEMBLY AND RECORDING MEDIUM DRIVE

(75) Inventor: Shigeru JUMAN, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/754,503

(22) Filed: Apr. 5, 2010

Related U.S. Application Data
(63) Continuation of application No. PCT/JP2007/069506, filed on Oct. 4, 2007.

(51) Int. Cl. G11B 5/55

(52) U.S. Cl. 360/264.7; G9B/5.182

(57) ABSTRACT

According to one embodiment, an assembly includes a first member configured to have a first linear expansion coefficient, a second member configured to have a second linear expansion coefficient smaller than the first linear expansion coefficient, a pair of connecting members configured to connect the first member with the second member, and a notch configured to be formed in the second member between the connecting members and configured to reduce a sectional area of the second member on a section perpendicular to a straight line that connects the connecting members.

### CROSS-REFERENCE TO RELATED APPLICATIONS

This application is a continuation of PCT international application Ser. No. PCT/JP2007/069506 filed on Oct. 4, 2007 which designates the United States, the entire contents of which are incorporated herein by reference.

### BACKGROUND

1. Field

One embodiment of the invention relates to an assembly that comprises a first member having a first linear expansion coefficient, a second member having a second linear expansion coefficient smaller than the first linear expansion coefficient, and at least a pair of connecting members that connects the first member with the second member.

2. Description of the Related Art

Recording medium drives, i.e., hard disk drives, comprise a carriage assembly housed in a housing. The carriage assembly reciprocates about a shaft. A flying head slider is mounted on the end of the carriage assembly. An electromagnetic transducer device on the flying head slider can be positioned at a desired recording track by the reciprocation of the carriage assembly.

A voice coil motor is connected to a carriage assembly to enable such reciprocation. A yoke for the voice coil motor is connected to a base made of aluminum of a housing with, for example, a pair of screws. The yoke for the voice coil motor is formed from, for example, an iron plate (see, for example, Japanese Patent Application Publication (KOKAI) No. 2006-13377).

When a hard disk drive is exposed to high temperature, a base and a yoke thermally expand. Abase made of aluminum expands further than a yoke made of iron. At this time, the extension of the base can be suppressed, because the tightening force of screws works on the base. A stress is accumulated in the base made of aluminum between a pair of screws. When the tightening force of the screws fails to suppress the expansion of the base, the base instantly extends. As a result of this, a misalignment between the base and the yoke occurs. The base strongly collides with the yoke to cause an impact in the yoke. When a flying head slider or a magnetic disk vibrates due to such an impact, the flying head slider moves off a targeted recording track. So-called off-track occurs. Therefore, data is written in a wrong neighboring recording track.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic plan view of a hard disk drive according to an embodiment of the invention;

FIG. 2 is an exemplary sectional view taken along line 2-2 of FIG. 1 in the embodiment; and

FIG. 3 is an exemplary partially enlarged plan view of a lower side yoke illustrated in FIG. 1 in the embodiment.

### DETAILED DESCRIPTION

Various embodiments according to the invention will be described hereinafter with reference to the accompanying drawings. In general, according to one embodiment of the invention, an assembly comprises a first member configured to have a first linear expansion coefficient, a second member configured to have a second linear expansion coefficient smaller than the first linear expansion coefficient, a pair of connecting members configured to connect the first member with the second member, and a notch configured to be formed in the second member between the connecting members and configured to reduce a sectional area of the second member on a section perpendicular to a straight line that connects the connecting members.

According to another embodiment of the invention, a recording medium drive comprises a base configured to have a first linear expansion coefficient, a yoke for a voice coil motor configured to have a second linear expansion coefficient smaller than the first linear expansion coefficient, a pair of connecting members configured to connect the base with the yoke for a voice coil motor, and a notch configured to be formed in the yoke between the connecting members and configured to reduce a sectional area of the yoke on a section perpendicular to a straight line that connects the connecting members.

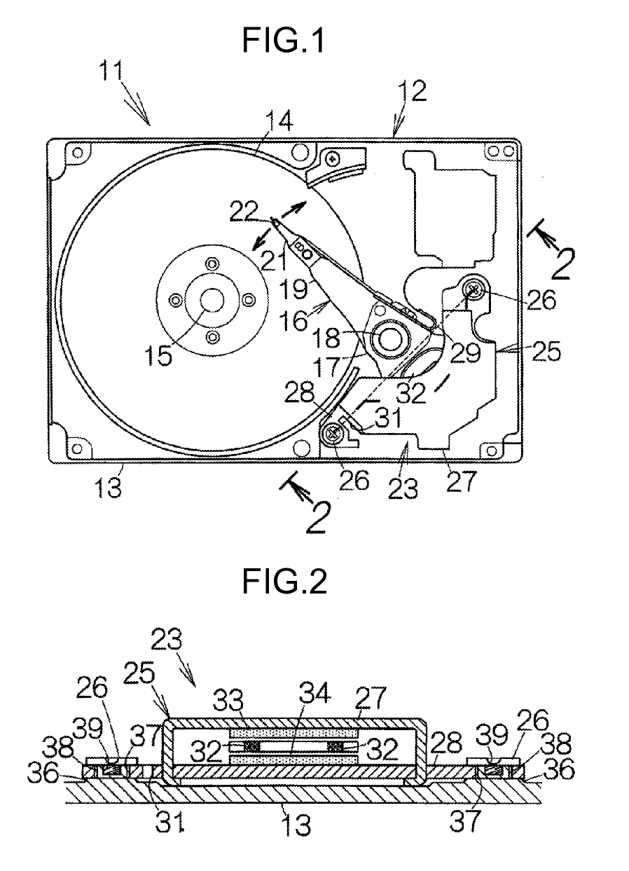

FIG. 1 schematically illustrates an internal structure of a hard disk drive (HDD) 11 as an example of a recording medium drive according to an embodiment of the invention. The HDD 11 comprises a housing 12. The housing 12 comprises a box-shaped base 13 and a cover (not illustrated). The base 13 defines, for example, a flat rectangular parallelepiped internal space. The base 13 may be formed by casting a metallic material such as aluminum. The cover is connected to an opening of the base 13. The internal space is sealed at a portion between the cover and the base 13. The cover may be formed by, for example, pressing a piece of plate.

In the internal space, i.e., a housing space, at least one magnetic disk 14 as a recording medium is housed. The magnetic disk 14 is mounted on a spindle motor 15. The spindle motor 15 can rotate the magnetic disk 14 at high speed of 3600 rpm, 4200 rpm, 5400 rpm, 7200 rpm, 10000 rpm, and 15000 rpm, for example.

In the housing space, a carriage assembly 16 is further housed. The carriage assembly 16 comprises a carriage block 17. The carriage block 17 is rotatably connected to a shaft 18 that extends in a vertical direction. With the carriage block 17, a plurality of carriage arms 19 that extends from the shaft 18 in a horizontal direction are integrated. The carriage block 17 may be formed by, for example, extruding aluminum.

A head suspension 21 is attached to the end of each of the carriage arms 19. The head suspension 21 extends from the end of the carriage arm 19 toward the front. A flexure is attached to the head suspension 21. A so-called gimbal is formed on the flexure at the front end of the head suspension 21. The gimbal supports a flying head slider 22 thereon. The gimbal enables the flying head slider 22 to change the position with respect to the head suspension 21. On the flying head slider 22, a magnetic head, i.e., an electromagnetic transducer device, is mounted.

When an air flow is produced on the surface of the magnetic disk 14 by rotation of the magnetic disk 14, positive pressure, i.e., buoyancy, and negative pressure act on the flying head slider 22 due to the air flow. When the buoyancy, the negative pressure, and a pressing force of the head suspension 21 are in balance, the flying head slider 22 can keep floating at relatively high stiffness during the rotation of the magnetic disk 14.

When the carriage assembly 16 rotates about the shaft 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic transducer device on the flying head slider 22 is positioned on the targeted recording track.

A power source such as a voice coil motor (VCM) 23 is connected to the carriage block 17. By the action of this VCM 23, the carriage block 17 can rotate about the shaft 18. Such rotation of the carriage block 17 enables reciprocation of the carriage arm 19 and the head suspension 21.

The VCM 23 comprises a yoke 25. The yoke 25 is fixed to the base 13 with, for example, a pair of connecting members, e.g., a pair of screws 26. The yoke 25 comprises an upper side yoke 27 and a lower side yoke 28. The upper side yoke 27 is connected to the lower side yoke 28. The upper side yoke 27 and the lower side yoke 28 are formed in flat plate shapes that extend along the arc centered on the shaft 18 between the pair of screws 26. In other words, the upper side yoke 27 and the lower side yoke 28 curve between the shaft centers of the pair of screws 26 while bypassing a virtual vertical plane 29 that connects the shaft centers of the pair of screws 26.

A notch 31 is formed in the edge of the lower side yoke 28 at the outside of the upper side yoke 27. The notch 31 opens outward from the shaft 18. The notch 31 passes through the virtual vertical plane 29 that connects the shaft centers of the pair of screws 26. The notch 31 reduces the sectional area of the lower side yoke 28 on such a section perpendicular to the virtual vertical plane 29.

An electromagnetic coil 32 is connected to the carriage block 17. As is apparent from FIG. 2, the electromagnetic coil 32 is arranged between the upper side yoke 27 and the lower side yoke 28. The upper side yoke 27 and the lower side yoke 28 face each other to define the space that expands horizontally in a sector shape around the shaft 18. The electromagnetic coil 32 is housed in this space. A pair of upper and lower permanent magnets 33, 34 is arranged in the space. The permanent magnets 33, 34 are fixed on the lower surface of the upper side yoke 27 and the upper surface of the lower side yoke 28, respectively. To be fixed in such a manner, the permanent magnets 33, 34 are formed in flat plate shapes to be overlapped on the upper side yoke 27 and the lower side yoke 28, respectively. The magnetic flux circulates in the upper side yoke 27 and the lower side yoke 28 by the action of such permanent magnets 33, 34. The upper side yoke 27 and the lower side yoke 28 form a closed magnetic path. The notch 31 is arranged outside of the permanent magnets 33, 34, i.e., outside of the upper side yoke 27. The notch 31 is formed in the lower side yoke 28 at the outside of the magnetic path. Therefore, the flow of the magnetic flux can be maintained.

As is apparent from FIG. 2, low height bosses 36, 36 are formed on the base 13 to fix the yoke 25. The lower side yoke 28 is received on the top surfaces of the bosses 36. A through hole 37 that perpendicularly extends from the top surface of each of the bosses 36 is formed on the lower side yoke 28. On the other hand, a receiving shaft 38 that coaxially extends from the boss 36 is formed on the top surface of each of the bosses 36. A screw hole 39 is formed in the receiving shaft 38 along the shaft center. When the shaft of the screw 26 is screwed into the screw hole 39, the lower side yoke 28 is caught between the head of the screw 26 and the top surface of the boss 36. The tightening force of the screw 26 acts on the lower side yoke 28 from the head of the screw. A play is provided between the outer surface of the receiving shaft 38 and the inner wall surface of the through hole 37.

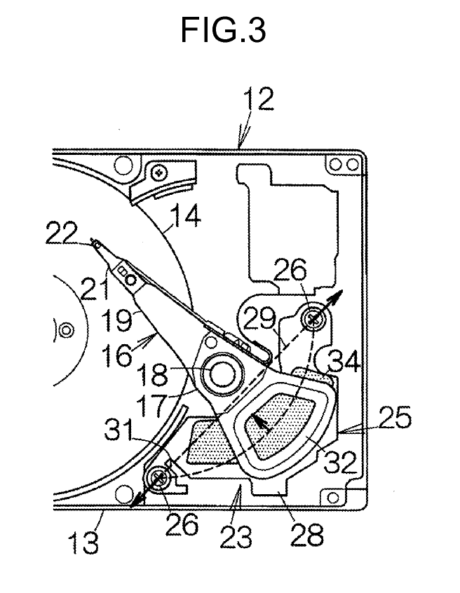

The upper side yoke 27 and the lower side yoke 28 are formed from a thick iron plate. Therefore, the upper side yoke 27 and the lower side yoke 28 have linear expansion coefficients smaller than that of the base 13 made of aluminum. Thus, the base 13 functions as the first member according an embodiment of the invention. The lower side yoke 28 functions as the second member according an embodiment of the invention. When the yoke 25 and the base 13 are exposed to high temperature, the base 13 thermally expands further than the yoke 25. Therefore, a pair of the bosses 36 moves away from each other. At this time, as is apparent from FIG. 3, the lower side yoke 28 is stretched between the pair of screws 26. The notch 31 expands corresponding to such stretch, because the sectional area of the lower side yoke 28 is reduced at the notch 31. Therefore, the lower side yoke 28 expands corresponding to the expansion of the base 13. The frictional force sufficiently acts on the lower side yoke 28 from the head of the screw 26 corresponding to the tightening force of the screw 26. A misalignment of the head of the screw 26 and the top surface of the boss 36 with the lower side yoke 28 is avoided. Thus, the occurrence of an impact caused by the expansion of the base 13 can be prevented.

Moreover, the lower side yoke 28 is formed from a flat plate that extends parallel to the surface of the base 13. The notch 31 is formed in the edge of such a flat plate. Such a notch can efficiently reduce the stiffness of the lower side yoke 28 in a direction parallel to the surface of the base 13, compared with a notch in the form of a groove, for example, formed on the surface of the lower side yoke 28. The lower side yoke 28 can deform relatively easily along the direction parallel to the surface of the base 13. Further, the lower side yoke 28 curves between the screws 26. The lower side yoke 28 bypasses the virtual vertical plane 29 that connects the shaft centers of the screws 26. As a result, during the expansion of the base 13, the lower side yoke 28 can deform easily. The expansion of the base 13 surely deforms the lower side yoke 28. Thus, a misalignment between the base 13 and the lower side yoke 28 can be surely avoided.

When the first member and the second member are exposed to high temperature, the first member and the second member thermally expand. The first member expands further than the second member, because the first linear expansion coefficient of the first member is larger than the second linear expansion coefficient of the second member. Therefore, the connecting members move away from each other. At this time, the second member is stretched between the pair of connecting members. The notch expands corresponding to such stretch, because the sectional area of the second member is reduced at the notch. Therefore, the second member expands corresponding to the thermal expansion of the first member. A misalignment between the first member and the second member is avoided. Thus, the occurrence of an impact can be prevented.

For the second member, a flat plate that extends along the surface of the first member and that defines the notch at the edge may be used. Such a notch can efficiently reduce the stiffness of the second member in a direction parallel to the surface of the first member, compared with a notch formed on the surface of the second member. The flat plate can deform relatively easily along the direction parallel to the surface of the first member.

At the same time, the second member desirably stretches between the connecting members while bypassing the straight line. Thus, the second member curves between the connecting members. Together with the notch, such a curve allows the second member to deform easily during the expansion of the first member. The expansion of the first member surely deforms the second member. A misalignment between the first member and the second member can be surely avoided.

When the base and the yoke for a voice coil motor are exposed to high temperature, the base and the yoke for a voice coil motor thermally expand. The base expands further than the yoke for a voice coil motor, because the first linear expansion coefficient of the base is larger than the second linear expansion coefficient of the yoke for a voice coil motor. Therefore, the connecting members move away from each other. At this time, the yoke for a voice coil motor is stretched between the pair of connecting members. The notch expands corresponding to such stretch, because the sectional area of the yoke for a voice coil motor is reduced at the notch. Therefore, the yoke for a voice coil motor expands corresponding to the thermal expansion of the base. A misalignment between the base and the yoke for a voice coil motor is avoided. Thus, the occurrence of an impact can be prevented.

In the same manner as described above, for the yoke for a voice coil motor, a flat plate that extends along the surface of the base and that defines the notch at the edge may be used. Such a notch can efficiently reduce the stiffness of the yoke for a voice coil motor in a direction parallel to the surface of the base, compared with a notch formed on the surface of the yoke for a voice coil motor. The flat plate can deform relatively easily along the direction parallel to the surface of the base.

The recording medium drive may further comprise a magnet attachable to the yoke for a voice coil motor between the connecting members. At this time, the notch may be formed at a portion between one of the connecting members and the magnet. Between the connecting members, the notch is arranged away from a magnetic path in the yoke for a voice coil motor. Therefore, the flow of the magnetic flux can be maintained.

In addition, as described above, the yoke for a voice coil motor desirably stretches between the connecting members while bypassing the straight line. Thus, the yoke for a voice coil motor curves between the connecting members. Together with the notch, such a curve allows the yoke for a voice coil motor to deform easily during the expansion of the base. The expansion of the base surely deforms the yoke for a voice coil motor. A misalignment between the base and the yoke for a voice coil motor can be surely avoided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An assembly comprising:
a base;
a yoke connected to the base with a plurality of connectors; and
a notch in the yoke and between the plurality of connectors, and configured to expand under increased heat so as to allow the yoke to expand together with an expansion of the base.

2. The assembly of claim 1, wherein the yoke comprises a flat plate along a surface of the base configured to define the notch at an edge of the yoke.

3. The assembly of claim 2, wherein the yoke is configured to stretch between the connectors while bypassing a straight line segment between the plurality of the connectors.

4. A recording medium drive comprising:
a base comprising a first linear expansion coefficient;
a yoke for a voice coil motor comprising a second linear expansion coefficient smaller than the first linear expansion coefficient;
a pair of connectors configured to connect the base with the yoke for the voice coil motor; and
a notch in the yoke between the connectors and configured to reduce a sectional area of the yoke perpendicular to a straight line segment between the connectors.

5. The recording medium drive of claim 4, wherein the yoke for a voice coil motor comprising a flat plate along a surface of the base configured to define the notch at an edge of the yoke for a voice coil motor.

6. The recording medium drive of claim 4, further comprising a magnet configured to be attached to the yoke for a voice coil motor between the connectors, wherein the notch is located at a portion between one of the connectors and the magnet.

7. The recording medium drive of claim 4, wherein the yoke for a voice coil motor is configured to stretch between the connectors while bypassing the straight line segment.
